(19) United States
(12) Patent Application Publication
(10) Pub. No.: US 2008/0225749 A1
(43) Pub. Date: Sep. 18, 2008

(54) Auto-configuration of a network device

(76) Inventors: Dennis Peng, Mountain View, CA (US); Jeff Peck, Los Altos, CA (US); Rex Fernando, San Jose, CA (US); Avneesh Sachdev, San Jose, CA (US); Simon Capper, Sunnyvale, CA (US)

Correspondence Address: CARR & FERRELL LLP, 2200 GENG ROAD, PALO ALTO, CA, 94303, US

(21) Appl. No.: 11/717,947

(22) Filed: Mar. 13, 2007

(51) Int. Cl. H04L 12/28

(52) U.S. Cl. 370/254; 726/4

(57) ABSTRACT

Exemplary systems and methods for auto-configuring a network device are provided. In exemplary embodiments, the network device receives network data, which is used to determine identification data for a client. A version of the client identification data is then sent to an ISP by the network device. In response, a public IP address is returned from the ISP. The network device then translates the public IP address into an internal IP address for use with the client. In some embodiments, the network device is verified by a central data center. In some embodiments, the network device may be provisioned for PSTN and/or VoIP calls.

### BACKGROUND OF THE INVENTION

1. Field of the Invention

Embodiments of the present invention relate generally to network devices, and more particularly to auto-configuration of a network device.

2. Description of Related Art

Presently, voice-over-IP (VoIP) is a quickly becoming a popular alternative to POTS (plain old telephone system) as a communication mechanism. Unfortunately, there are a number of disadvantages in terms of installation that face existing VoIP products and home networking products in general. For example, when a network device is placed into a network, the network device must be configured with a set of parameters in order to function. The configuration process may be time consuming and confusing to some users.

Currently, there are several topologies that exist in utilizing a network device. The first topology is a cable topology. The cable topology utilizes a well defined protocol that allows a new network device to connect to the network and auto-configure itself.

The second topology is a DSL or ADSL topology. In this topology, point-to-point protocol over Ethernet (PPPoE) may be utilized. PPPoE is typically associated with a set of authentication credentials, such as a user name and password. As such the first layer-3 networking device needs to be configured when it is installed into the network.

Typically, a router has a configuration page that allows a user to map a public IP address (e.g., 171.68.1.1) to a private IP address (e.g., 192.168.10). When a data package comes in via a modem, the router translates a destination address to the private address for a coupled personal computer (e.g., 192.168.1.10). However, if a network device is placed in-between the modem and router, the network device, which comprises a different address and is not aware of the current mapping, will break the connection from the modem through the router. Furthermore, the network device will need to be configured to operate in the network.

### SUMMARY OF THE INVENTION

Embodiments of the present invention provide systems and methods for auto-configuring a network device. In exemplary embodiments, the network device receives network data, which is used to determine identification data for a client (or a router). A version of the client identification data is then sent to an ISP. In response, a public IP address is returned from the ISP. The network device then translates the public IP address into an internal IP address for use by the client.

In various embodiments, the data transfer between the client and the network device is via PAP, CHAP, or DHCP, and data transfer between the network device and the ISP may be via PAP, CHAP, or DHCP, respectively. In some embodiments, a hybrid of PAP/CHAP may be utilized whereby communications between the client and the network device is via PAP and communications between the network device and the ISP is via CHAP.

In some embodiments, the network device is verified by a central data center. A DTMF tone sequence may be provided to the network device by the central data center via a SSL connection. The network device then calls, via PSTN, the central data center and provides the same DTMF tone sequence back to the central data center. If the DTMF tone sequences match, the network device is verified.

In some embodiments, the network device may be provisioned by a PSTN call. In the case of the PSTN provisioning, when the network device calls the central data center, the network device's phone number is determined by the central data center via ANI. The phone number is then provided back to the network device. As a result, the network device may be verified to exist at a particular phone number.

A user may configure their preferences via, for example, a web page associated with the central data center. The preferences are then stored in a data repository, and used to provision the network device.

### BRIEF DESCRIPTION OF PROPOSED FIGURES

FIG. 1 is a diagram of an exemplary environment in which embodiments of the present invention may be practiced.

FIG. 2 is a block diagram of an exemplary network device.

FIG. 3 is a flowchart of an exemplary method for auto-configuring a network device.

FIG. 4a is a flow diagram of an exemplary DHCP auto-configuration process.

FIG. 4b is a flow diagram of an exemplary PAP auto-configuration process.

FIG. 4c is a flow diagram of an exemplary CHAP/PAP hybrid auto-configuration process.

FIG. 4d is a flow diagram of an exemplary CHAP auto-configuration process.

FIG. 5 is a flowchart of an exemplary implementation of the auto-configuration method in a VoIP network.

### DETAILED DESCRIPTION OF EXEMPLARY EMBODIMENTS

Embodiments of the present invention provide an exemplary system and method for auto-configuring a network device. In exemplary embodiments, a network device is installed into an internal network. The internal network may comprise any type of network (e.g., a home network). The network device is then auto-configured to operate within the internal or private network without user intervention.

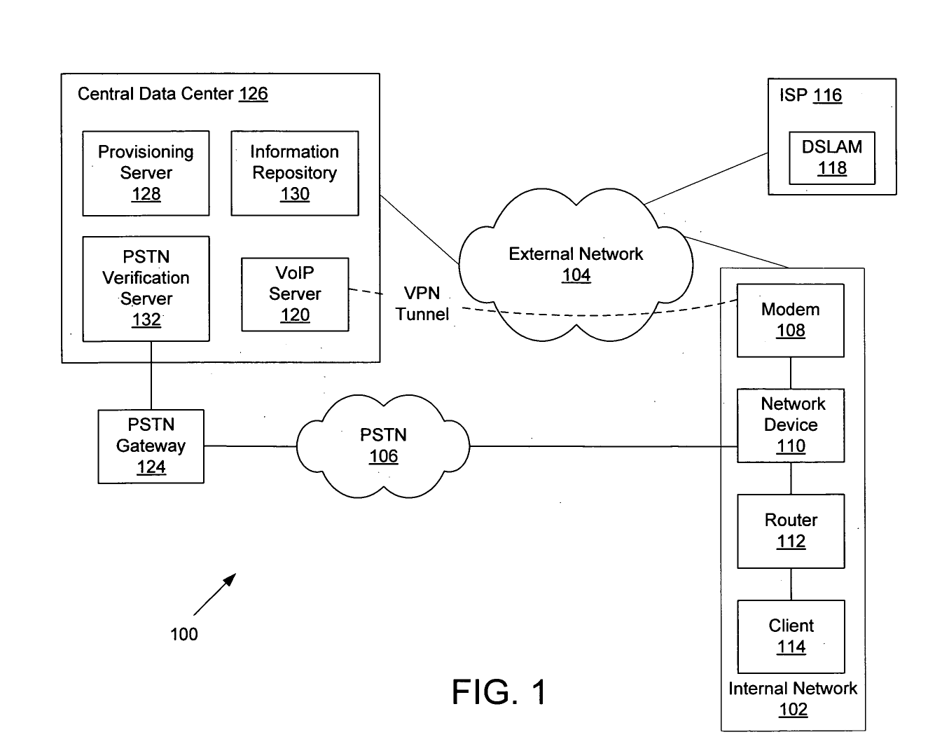

Referring to FIG. 1, a block diagram of an environment 100 in which embodiments of the present invention may operate is shown. In exemplary embodiments, an internal network (i.e., LAN) 102 is coupled in communication to an external network 104 and a public switched telephone network (PSTN) 106. The external network (WAN) 104 may comprise any type of network such as the Internet.

The internal network 102 may comprise a modem 108, a network device 110, a router 112, and a client 114. In one embodiment, the network device 110 comprises a DSL device. According to exemplary embodiments, the network device 110 is a device located at a chock point on the internal network 102 where data from the external network 104 enters and interfaces with the internal network 102. Thus, the network device 110 may be coupled between the modem 108 and the router 112 according to exemplary embodiments. The exemplary network device 110 is configured to control quality of service for a voice connection. Furthermore, because the network device 110 is between the modem 108 and router 112, the network device 110 may interject in communications between the modem 108 and the router 112, and, in some embodiments, snoop protocols. Information obtained from snooping the protocols, such as authentication credentials, may then be used to auto-configure the network device 110 in accordance with some embodiments of the present invention. Because the router 112 and/or the client 114 is already configured and has knowledge of certain information (e.g., password), the information can be used to auto-configure the network device 110.

In the absence of an API or a protocol for deterministic retrieval of this information, existing network protocols may be used. In these embodiments, the network device 110 will impersonate either the modem 108 or the router 112 when in communication with the other respective device (i.e., router 112 or modem 108). The various methods for auto-configuring the network device 110 will be discussed in more detail below.

Via the modem 108, the client 114 may communicate with an Internet Service Provider (ISP) 116. In various embodiments, the ISP 116 will comprise a DSL Access Multiplexor (DSLAM) 118 which intermixes voice traffic and DSL traffic onto a customer's phone line. The DSLAM 118 also separates incoming phone and data signals and directs them onto an appropriate carrier's network. In an alternative embodiment, the ISP may comprise a cable modem termination system (CMTS) configured to enable cable modems to send and receive packets over the external network 104. In yet other embodiments, the ISP 116 comprises a broadband remote access server (BRAS).

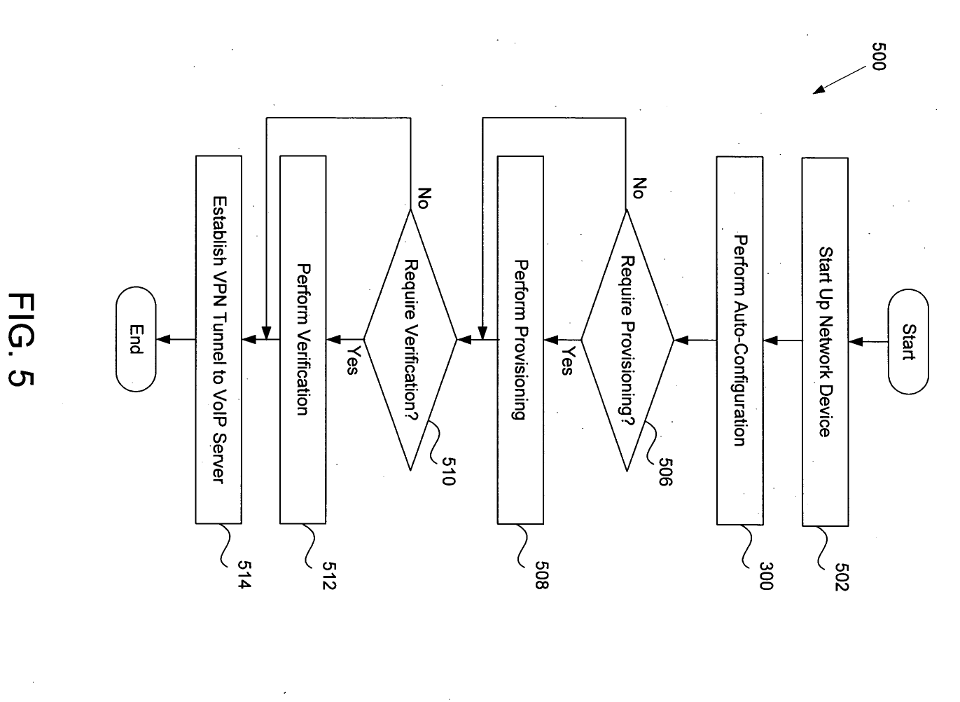

Additionally, the client 114 may communicate with a VoIP server 120 via a VPN tunnel, as will be discussed further in connection with FIG. 5. In exemplary embodiments, the VoIP server 120 is embodied within a central data center 126. In other embodiments, the VoIP server 120 may be located anywhere in the environment 100.

Via the PSTN 106 and a PSTN gateway 124, the client 114 may also communicate with the central data center 126. The central data center 126 is configured to manage the auto-configuration of the network device 110. In exemplary embodiments, the central data center 126 comprises a provisioning server 128, an information repository 130, a PSTN verification server 132, and the VoIP server 120. Provisioning and verification will be discussed in further details in connection with FIG. 5 below.

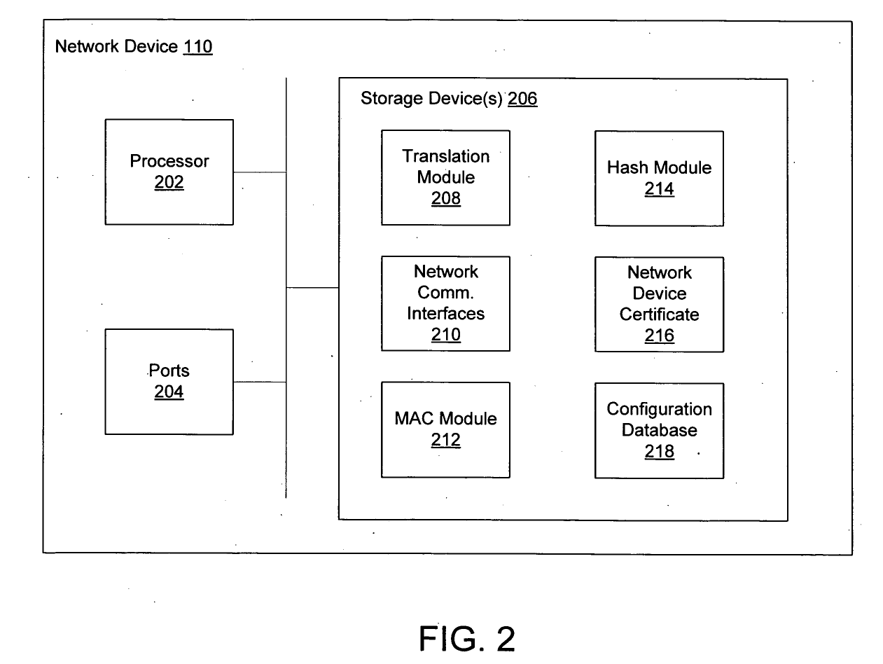

Referring now to FIG. 2, a block diagram of the exemplary network device 110 is shown. In exemplary embodiments, the network device 110 comprises a processor 202, communication ports 204, and at least one storage device 206. The communication ports 204 are configured to facilitate communications to and from the modem 108 and the router 112 and/or client 114. The storage devices 206 may comprise any type of device or memory that stores data. In exemplary embodiments, the storage device 206 comprises a network translation module 208, a network communication interface 210, a MAC module 212, a hash module 214, a DSL device certificate 216, and a configuration database 218.

The exemplary network translation module 208 is configured to perform IP address translations or mappings. In exemplary embodiments, the installation of the network device 110 breaks some services that are running in the internal network 102 such as web services and FTP services (e.g., forwarding from a public IP address into a specific IP address that is hosting the service). As such, the network device 110 introduces a layer of network address translation (NAT) that breaks the mapping. Once installed, the network device 110 is assigned a public IP address. The router 112 has a different IP address assigned by PPPoE or Dynamic Host Configuration Protocol (DHCP). Thus, when a communication comes in, it is directed to the network device 110, which forwards it to the router 112 and subsequently to the client 114. In order to avoid having a user configure the network device 110 with a static mapping, a mapping that incorporates a catch-all for unused ports (e.g., 171.68.1.1:*, where * is all ports) may be utilized. As such, the network translation module 208 maps all ports that are open on the WAN 104 side and known to the network device 110 to a specific IP address that exists on the LAN 102 side. In the present embodiment, the specific IP address is for the router 112.

The exemplary network communication interfaces 210 are configured to facilitate communication. In various embodiments, the network communication interface 210 identifies the type of protocol being utilized by the networks 102 and 104. Based on the type of protocol, the network device 110 will perform the auto-configuration accordingly as will be discussed further below.

The MAC module 212 is configured to determine and maintain media access control (MAC) address information for each client 114 that is coupled to the network device 110. If more than one MAC address (e.g., from two different clients 114) are available, then the MAC address for the network device 110 or the MAC address of one of the devices (e.g., client 114) may be utilized. The use of MAC address information will be discussed in more detail below.

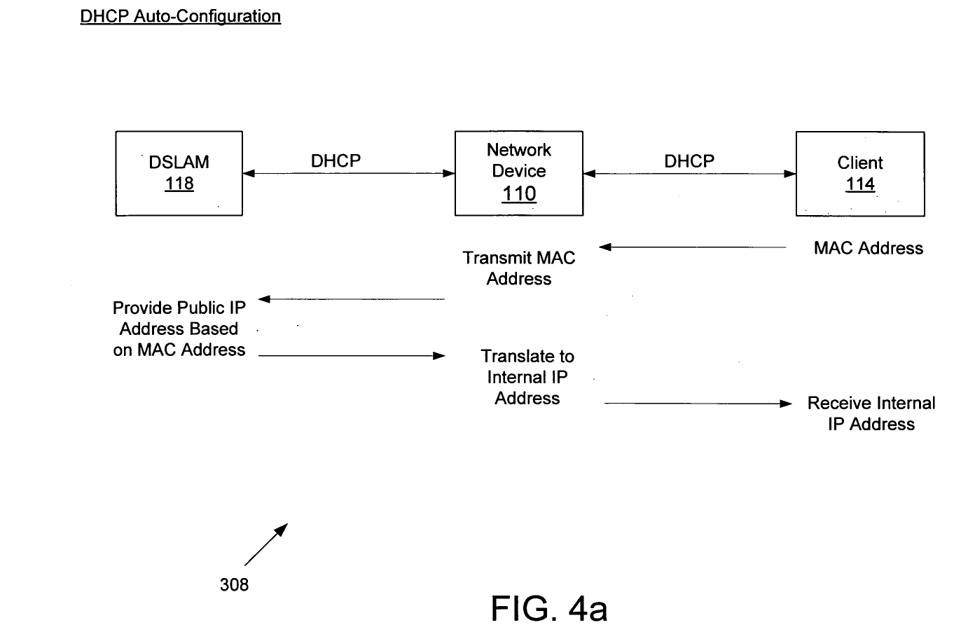

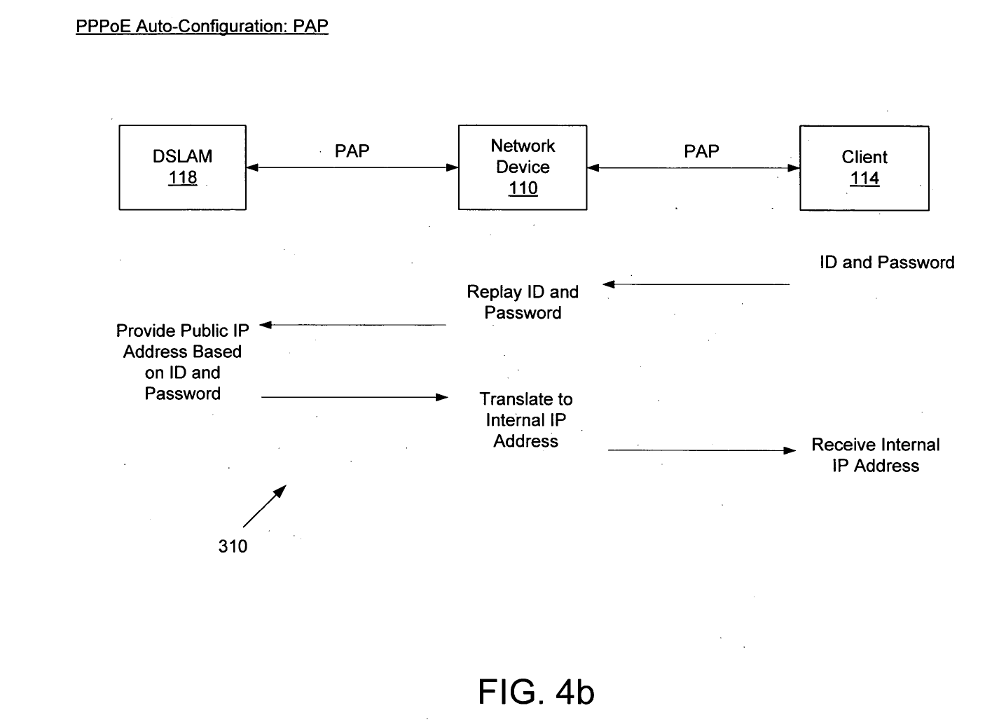

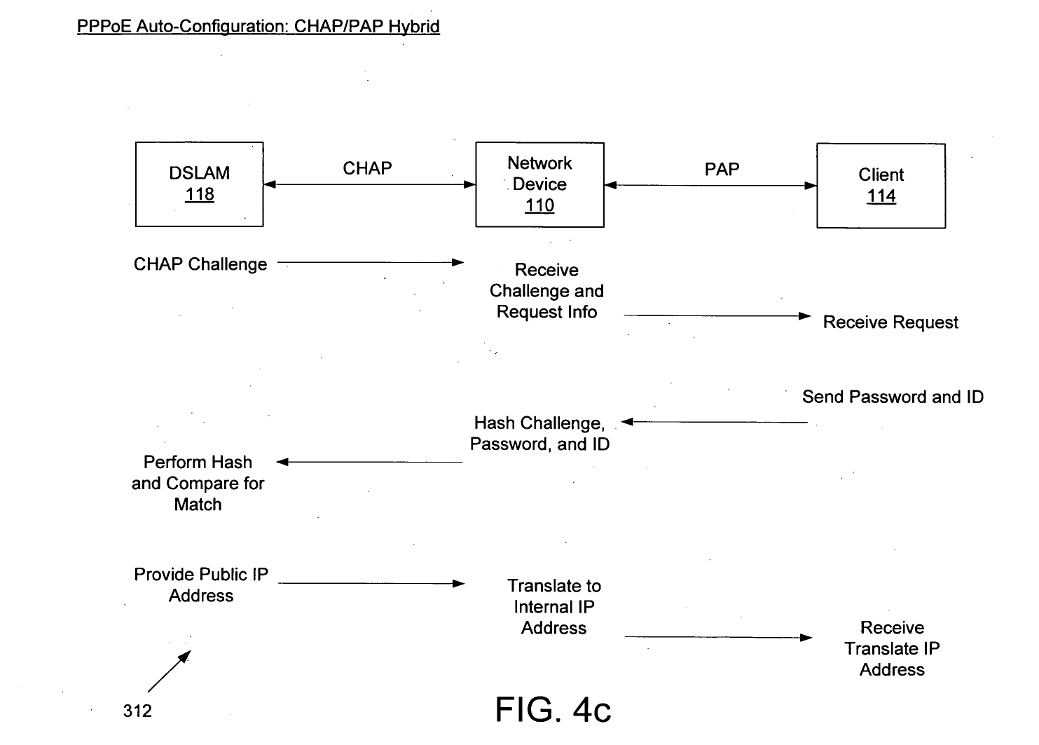

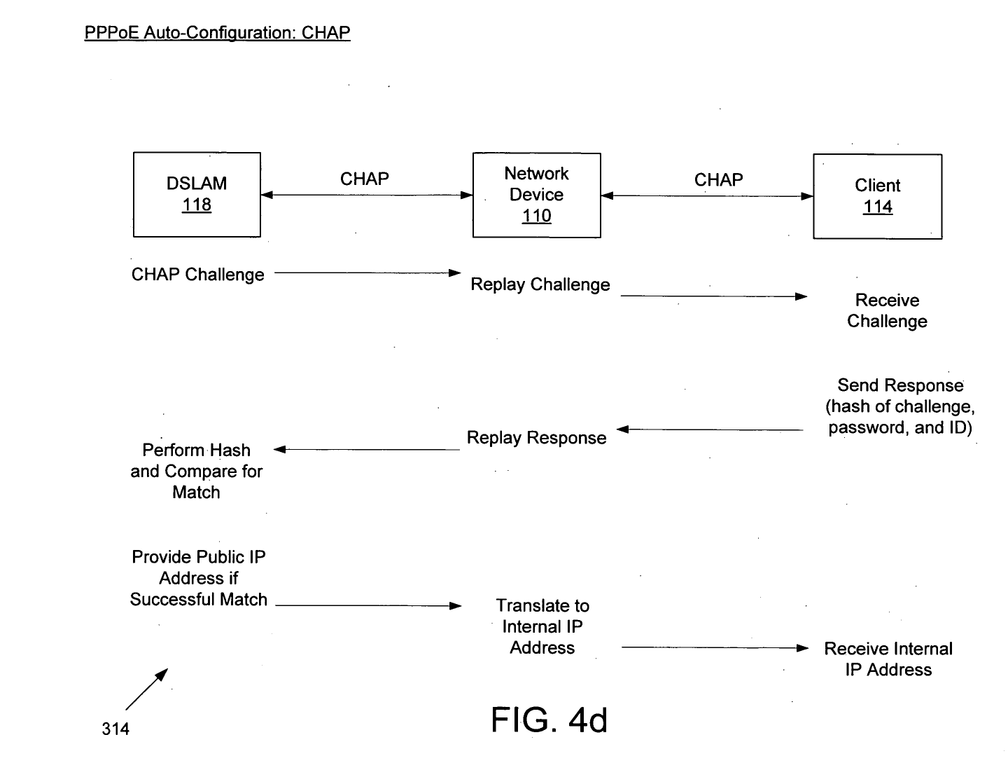

The hash module 214 is configured to perform a hash on data as will be described in more detail in connection with FIG. 4c and FIG. 4d.

The exemplary network device certificate 216 comprises a digital certificate that identifies the network device 110. The network device certificate 216 is used, in some embodiments, to verify the network device 110 with the PSTN verification server 132 as will be discussed below. According to one embodiment, the network device certificate 216 identifies a DSL device.

The configuration database 218 is configured to store a last known good protocol and parameters that worked for the network device 110. Thus according to some embodiments, the next time the network device 110 requires reconfiguration, a look up in the configuration database 218 may be performed and the stored configuration and set of parameters are used as default.

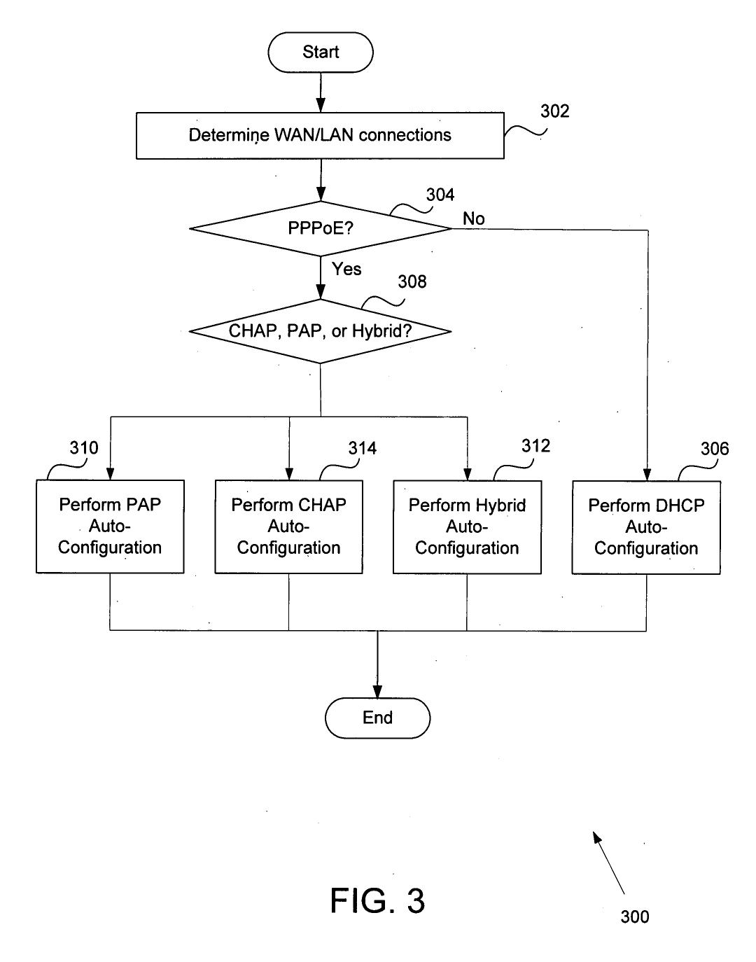

Referring now to FIG. 3, a flowchart of an exemplary method for auto-configuring the network device 110 is shown. In optional step 302, the network device 110 determines the WAN/LAN connections. In exemplary embodiments, there are two communication ports 204 in the network device 110—one for the WAN 104 side and one for the LAN 102 side. When two cables are plugged into the network device 110, the network communication interfaces 210 determine based on an analysis of communication traffic being received at each port 204 which side of the network is plugged into each port 204. In a cable topology, the determination may be based on cable characteristics. For example, in a cable environment, the network device 110 will receive a large number of Address Resolution Protocol (ARP) requests. By measuring a rate of the ARP requests, once a threshold is surpassed on one side, that side is identified as the WAN 104 side of the network. In the DSL topology, the network device 110 measures a rate of PPPoE packages to identify the WAN 104 side.

In step 304, the network device 110 determines if PPPoE is being used. PPPoE is one type of protocol used on a DSL network. If PPPoE is not use, then in step 306, DHCP auto-configuration is performed. DHCP auto-configuration will be discussed in more detail in connection with FIG. 4a.

If PPPoE is used, then in step 308, a determination is made as to whether Challenge Handshake Authentication Protocol (CHAP), Password Authentication Protocol (PAP), or a hybrid of CHAP/PAP is used to authenticate the network device 110. If PAP is utilized, then the process proceeds to step 310. Step 310 will be described in more detail in connection with FIG. 4b. If a hybrid of CHAP/PAP is utilized, then the process proceeds to step 312, which will be described in more detail in connection with FIG. 4c. Finally, if CHAP is utilized, then the process proceeds to step 314, which is discussed in more detail in connection with FIG. 4d.

For simplicity, the following discussions of auto-configuration are provided utilizing the DSLAM 118 and the client 114. However, it should be understood that other devices may be used without departing from the scope of embodiments of the present invention. For example, a CMTS may be utilized instead of the DSLAM 118. Similarly, the router 112 may be utilized instead of the client 114.

FIG. 4a illustrates a flow diagram of the exemplary DHCP auto-configuration process (step 306). When using a cable topology, DHCP may be utilized for auto-configuration. Typically, the cable topology will comprise a standard mapping between a MAC address and an IP address. Thus, in the prior art, the router 112 and the modem 108 connection has a mapping between the MAC address (of the router 112) and the IP address (at the modem 108). The introduction of the network device 110, in the present embodiments, will introduce a DHCP request having a different MAC address (i.e., the MAC address of the network device 110). As a result, the network device 110 may be unable to receive (or incur a significant delay in receiving) an IP address in response from the CMTS since a DHCP server may be expecting the MAC address of the router 112. In order to resolve this problem, embodiments of the present invention automatically clone the MAC address from a device of the internal network 102 (e.g., the router 112) and use the cloned MAC address for issuing requests.

As shown in FIG. 4a, a MAC address of the client 114 is received by the network device 110. The network device 110 then clones the client 114 MAC address and transmits the cloned MAC address to CMTS. In response, a public IP address based on the cloned MAC address is provided. This public IP address is received by the network device 110, which then translates the public IP address via the network translation module 208 into an internal IP address. The internal IP address is then forwarded to the client 114.

Referring now to FIG. 4b, a PPPoE auto-configuration process is shown. In the present embodiment, the PPPoE auto-configuration uses PAP as the authentication protocol. During the PAP authentication phase, the client 114 sends an authentication request to the network device 110. The authentication request may comprise an identifier associated with the client 114 and password or other form of credential from the client 114. In some embodiments, the credentials are in plain text. The network device 110 will replay the authentication request to the DSLAM 118. If successful, the DSLAM 118 will provide a public IP address based on the identifier and password to the network device 110. Upon receipt, the network device 110 will, via the network translation module 208, translate the public IP address into an internal IP address, and forward the internal IP address to the client 114.

In some embodiments, the determination of whether to use PAP or CHAP is performed by the ISP 116. In other embodiments, the client 114 may reject the use of PAP, for example, because it is deemed an unsecured protocol. In yet other embodiments, the network device 110 may chose to implement a hybrid authentication process. It should be noted that the router 112 or client 114 may need to be powered on in order for the hashing to be completed and the exchange of data to occur. If, for example, the client 114 is powered off, the network device 110 may need to initiate a session regardless of the presence of the router 112 or the client 114. This can be insured, in various embodiments, by the network device's 110 ability to influence the authentication process used. As a result, a hybrid of PAP and CHAP authentication may be performed.

FIG. 4c illustrates one embodiment of this hybrid process. The present hybrid process comprises CHAP authentication data exchange between the DSLAM 118 and the network device 110, and PAP authentication data exchange between the network device 110 and the client 114. In this embodiment, the network device 110 receives a CHAP challenge comprising a random number string from the DSLAM 118, and forwards a request for information to the client 114. In the present embodiment, the request for information is a PAP request. In response, the client 114 provides an identifier and password to the network device 110.

Using the received identifier and password (e.g., a PAP authentication request), the hash module 214 of the network device 100 performs hashing on the random number string, identifier, and password. The result of the hashing performed by the network device 110 is relayed to the DSLAM 118 in CHAP. As such, the network device 110 in the present embodiment is the “secret holder.”

The DSLAM 118, based on the received identifier and password, performs a similar hashing function. The results of the DSLAM 118 hash is compared to the result of the network device 110 hash. If a match occurs, then a public IP address is returned to the network device 110. The public IP address is then translated to an internal IP address by the network device 110, and forwarded to the client 114.

Referring now to FIG. 4d, a PPPoE auto-configuration process using CHAP as the authentication protocol is shown. In exemplary embodiments, CHAP auto-configuration process is performed when the hybrid process described in connection with FIG. 4c is not available. CHAP authentication requires a more complex series of data exchanges to occur over that of PAP. During the CHAP authentication, a CHAP challenge from the DSLAM 118 is received by the network device 110. The CHAP challenge may comprise a random number string that changes every time. The CHAP challenge is a more complex protocol whereby the password is never passed in a clear check. As a result, the networking device 110 cannot sniff and display the password. Instead, the CHAP challenge is replayed by the network device 110 to the client 114.

In reply to the CHAP challenge, the client 114 sends a response to the network device 110. The response may comprise a concatenation of the random number from the CHAP challenge along with an identifier and password. In some embodiments, the contents of the response may be hashed.

The response is replayed by the network device 110 to the DSLAM 118. The DSLAM 118 will perform hashing using the same random number, identifier, and password. The results are compared to those received from the client 114 via the network device 110 for a match. If a match occurs, then a public IP address is returned to the network device 110. Upon receipt of the public IP address, the network device 110 will translate the public IP address into an internal IP address, which is forwarded to the client 114.

FIG. 5 is a flowchart 500 of an exemplary implementation of the auto-configuration method in a VoIP network. In step 502, the network device 110 is powered on. In some embodiments, the network device 110 may be installed in-between the modem 108 and the router 112 or client 114. As a result of the installation and/or power on, auto-configuration is performed in step 504. Performance of auto-configuration will provide a public and private IP address for use by the network device 110. Exemplary embodiments of various auto-configuration processes have been discussed in connection with FIG. 4a through FIG. 4d.

Next in step 506, a determination is made as to whether provisioning is required. Provisioning comprises setting up a telecommunications service associated with the network device 110. Provisioning is typically required when the network device 110 is first installed in the internal network 102 or if the network device 110 has changed locations. In exemplary embodiments, a phone number associated with the network device 110 needs to be determined in order for the network device 110 to function in the VoIP network. Provisioning will determine the phone number associated with the network device 110.

According to exemplary embodiments, the network device 110, via the modem 108, makes a secured web connection using SSL (secure socket layer) to the provisioning server 128 of the central data center 126. Once the connection is established, the network device 110 may identify itself using an identifier and/or the network device certificate 216 (e.g., X.509 certificate). The provisioning server 128 may detect, based on the identifier and/or the network device certificate 216, that the network device 110 is a new network device or has changed locations, and thus requires provisioning. In one embodiment, the provisioning server 128 may compare the identifier and/or network device certificate with identifiers and network device certificates of previously provisioned network devices stored in the information repository 130.

If provisioning is required, then provisioning is performed in step 508. In some embodiments, the provisioning server 128 sends an identification string to the network device 110. In one embodiment, the identification string is a sequence of DTMF tones.

The provisioning server 128 will also request that the network device 110 place a PSTN call to the central data center 126. In exemplary embodiments, the network device 110 will access the PSTN verification server 132 of the central data center 126 via the PSTN 106 and the PSTN gateway 124. Once the network device 110 contacts the PSTN verification server 132, an associated phone number based on an automatic number identification (ANI) is detected by the PSTN verification server 132. In some embodiments, the network device 110 may also provide the network device identifier to the PSTN verification server 132. The PSTN verification server 132 then sends the detected phone number back to the network device 110 so that the network device 110 now knows its own phone number.

In step 510, the central data center 126 determines if the network device 110 needs to be verified. In various embodiments, verification is required if the network device 110 is a new device, if the network device 110 has been inactive for a long period of time, or if a predetermined period of time has elapsed.

If verification is required, then in step 512, the verification process is performed. According to exemplary embodiments, the network device 110 provides a copy of the identification string that it received from the provisioning server 128. The PSTN verification server 132 compares the identification string received from the network device 110 with all identification strings sent by the provisioning server 128 to identify and verify the network device 110 with the provisioning server 128. The corresponding identifier and phone number is also sent to the provisioning server 128. The network device identifier, phone number, and a timestamp may then be stored in the information repository 130.

If verification is not required in step 510, then the identification string provided by the provisioning server 128 does not need to be sent to the network device 110. As such, some embodiments of the present invention may perform steps 508 and 512 simultaneously or in reverse order.

As added security, the PSTN verification server 132 may make a return PSTN call to the network device 110 while the first PSTN call (from the network device 110) is still activated. Because the first PSTN call is still active, the return PSTN call should receive a busy signal. Alternatively, the PSTN verification server 132 may make a return PSTN call to the network device 110 after the first PSTN call terminates. The network device 110 in this embodiment will then report the PSTN verification server number back to the PSTN verification server 132. In yet another embodiment, the PSTN verification server 132 may break the first PSTN call after receiving the identifier and phone number. The PSTN verification server 132 then places a PSTN call back to the received phone number.

Once the network device 110 is verified, the central data center 126 will know who and where all network devices 110 are located. As such, the central data center 126 is able to verify the identity and/or location of the network devices 110 to third parties, such as an e-commerce party.

In step 514, a VPN tunnel to the VoIP server 120 is established. In exemplary embodiments, the provisioning server 128 provides a VPN key to the network device 110 after the network device 110 has been verified. The VPN key allows the network device 110 to access or build a VPN tunnel to the VoIP server 120. As such, a third IP address may be assigned to the network device 110 for the purpose of accessing a VPN concentrator of the VoIP server. In some embodiments, the VoIP server 120 is located at the central data center 126. In these embodiments, the VPN tunnel is built back to the central data center 126.

Once the network device 110 obtains the public IP address and parameters needed to communication on the external network 104, the network device 110 may VPN back to the central data center 126 in order to provision itself (i.e., configure to a specific customer) for VoIP calls. Typically, there are a number of customer choices for personalization of VoIP calls. In exemplary embodiments, the configuration is performed via a website. For example, the client 114 may access www.ooma.com/myaccount, which is associated with the central data center 126, to enter their configuration preferences. The configuration preferences may then be stored in the information repository 130. In various embodiments, configuration preferences may comprise all personalization preferences available on telecommunication devices including, for example, a number of rings before the call rolls over to voicemail or call forwarding options.

In various embodiments, a check of the information inventory 130 may be performed. For example, a database check may be performed to determine if it is proper for the network device 110 to join the external network 104. Additionally, a check may be performed to determine if other network devices 110 having the same network device certificate and password are located on the external network 104.

At predetermined times or events, the provisioning process (step 508) may be re-performed to insure that the network device 110 is still associated with the last known phone number. For example if the VPN tunnel is maintained, then the provisioning server 128 knows that the network device 110 has not moved. Even if the VPN tunnel is inactive for a short period of time, provisioning may not need to be performed again. However, if the VPN tunnel is inactive for a significant period of time, then provisioning may need to be performed in order to insure that a proper phone number is associated with the network device 110.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

1. A method for auto-configuring a network device, comprising:
receiving network data;
determining client identification data from the network data;
forwarding a version of the client identification data to an ISP;
receiving a public IP address from the ISP; and
translating the public IP address into an internal IP address.

2. The method of claim 1 wherein the client identification data comprises a MAC address.

3. The method of claim 1 wherein the client identification data comprises a user name and password.

4. The method of claim 1 wherein the version of the client identification data comprises the client identification data.

5. The method of claim 1 wherein the version of the client identification data comprises a hash of a challenge and the client identification data.

6. The method of claim 1 further comprising determining a type of protocol to use in auto-configuring the network device.

7. The method of claim 6 wherein the type of protocol comprises DHCP.

8. The method of claim 6 wherein the type of protocol comprises PPPoE.

9. The method of claim 8 further comprising using PAP to authenticate the network device.

10. The method of claim 8 further comprising using CHAP to authenticate the network device.

11. The method of claim 8 further comprising using a CHAP/PAP hybrid to authenticate the network device.

12. The method of claim 1 wherein the network data comprises a challenge.

13. The method of claim 1 further comprising receiving provisioning data from a provisioning server.

14. The method of claim 13 wherein the provisioning data comprises configuration preferences provided by a user on a website associated with the provisioning server.

15. The method of claim 1 further comprising performing a verification process via a PSTN.

16. The method of claim 15 wherein performing the verification process comprises receiving a unique signal from a first server and forwarding the unique signal and an automatic number identification to a second server via a phone call over the PSTN.

17. The method of claim 16 wherein the unique signal is a DTMF sequence.

18. The method of claim 16 further comprising verifying the unique signal, a network device certificate, and an automatic number identification received at the second server with the first server.

19. The method of claim 1 further comprising establishing a VPN tunnel to a VoIP server using the VPN key.

20. The method of claim 19 further comprising monitoring the VPN tunnel to determine if a new verification process is required.

21. A system for auto-configuring a network device, comprising:
a network communication interface configured to receive and send network data;
a client identity module configured to determine client identification data from the network data and use a version of the client identification data to obtain a public IP address; and
a translation module configured to translate the public IP address received from an ISP into an internal IP address.

22. The system of claim 21 wherein the client identity module comprises a MAC module configured to determine a MAC address.

23. The system of claim 21 wherein the client identity module comprises a hash module configured to hash a challenge and the client identification data.

24. The system of claim 21 further comprising a network device certificate configured to uniquely identify the network device.

25. The system of claim 21 further comprising a provisioning server configured to provide provisioning data to the network device.

26. The system of claim 21 further comprising a PSTN verification server configured to verify a network device phone number and network device certificate.

27. A machine-readable medium having embodied thereon a program, the program comprising instructions for a method for auto-configuring a network device, the method comprising:
receiving network data;
determining client identification data from the network data;
forwarding a version of the client identification data to an ISP;
receiving a public IP address from the ISP; and
translating the public IP address into an internal IP address.
